(19) United States
(12) Patent Application Publication
(10) Pub. No.: US 2004/0187031 A1
(43) Pub. Date: Sep. 23, 2004

(54) Trust management

(76) Inventor: Alan Thomas Liddle, Havant (GB)

Correspondence Address: FAEGRE & BENSON LLP, PATENT DOCKETING, 2200 WELLS FARGO CENTER, MINNEAPOLIS, MN, 55402, US

(21) Appl. No.: 10/484,158

(22) PCT Filed: Jul. 16, 2002
(86) PCT No.: PCT/GB02/03258

(30) Foreign Application Priority Data
Jul. 17, 2001 (GB) 0117429.1

(51) Int. Cl. H04L 9/32

(52) U.S. Cl. 713/201

(57) ABSTRACT

A method for facilitating interactions via communications networks between computer systems of entities (A, B), wherein each entity belongs to a respective one of a plurality of different trust domains (TD1, TD2). The method comprises the steps of creating a trust community which encompasses the trust domains, allowing each entity in the community to define its own trust and security policy rules, and using a central body to enforce the entity rules of each entity within the community.

This invention relates to methods, systems and apparatus in the field of trust management, electronic security etc.

There are a vast number of circumstances where electronic transactions between different entities need to take place. In nearly all of these there needs to be some level of assurance that the transaction is as it seems and the parties know who each other are. Often there must also be a decision as to whether or not the transaction should continue.

Public key cryptography is one important technique used to facilitate these transactions. However, since the introduction of public key cryptography and infrastructures to support it there have been problems due to a lack of interoperability.

Some of these problems have arisen because, at least in the early development of such techniques, the use of hierarchical structures has dominated. These methodologies based on a single root controlled by a trusted third party are not sophisticated enough or flexible enough to deal with the many different situations which can arise.

One approach which has been used to deal with more complex situations is that of cross certification, where one trust domain accepts certificates from another domain, once the cross certification has taken place. However, this simply enacts a union of the two trust domains. Where there are a large number of trust domains all of which may be interacting with one another, a ridiculously complex matrix or web of cross certifications can build up.

Another approach is the use of a bridge or hub certification authority. In this case there is a single entity with which the different trust domains may each cross certify. However, both the simple cross certification model and those models using a hub or bridge certification authority still suffer from problems.

One of the main problems is that once cross certification has taken place each member of the respective trust domains is typically in a position where it must trust every user within each of the domains and for all transactions. This blanket level of trust is often inappropriate as, for example, there may be a complex set of circumstances where one party will trust another in respect of certain actions or transactions but not in respect of others.

Again, efforts have been made to try and overcome this problem by implementing mechanisms for controlling what degree of trust one party has in respect of another and what actions or privileges each party can have when interacting with each other party. However, these existing mechanisms, such as using attribute certificates where all of the additional information is provided along with the certificate, have generally proved to be unworkable.

Work in this area has highlighted the difficulty in establishing policies for interoperability and interoperation in a pragmatic solution which also meets the needs for mechanisms to enforce the policies.

It is therefore an object of the present invention to provide methods, apparatus and systems for facilitating transactions between entities which belong to different trust domains whilst allowing those entities to control the level of trust which they give, and/or control other aspects relating to electronic security.

At least as far as this application is concerned a trust domain is thought of as being brought about by a body (which itself might also be termed a trust domain) which acts as a source of trust for those sets of individuals and/or organisations that are encompassed within the domain. An organisation that issues digital certificates to its employees may be seen as establishing a trust domain. If that organisation then issues digital certificates to other entities, they may then also be seen as being a part of its trust domain.

According to one aspect of the invention there is provided a method for managing interactions between entities each belonging to a respective one of a plurality of different trust domains comprising the steps of:

creating a trust community which encompasses the trust domains; and

controlling the activities of entities within the community.

According to another aspect of the invention there is provided a method for managing interactions between entities each belonging to a respective one of a plurality of different trust domains comprising the steps of:

creating a trust community which encompasses the trust domains;

allowing each trust domain to define its own security policy rules; and

providing a central body to enforce the security policy rules of each trust domain within the community.

According to another aspect of the invention there is provided a method for facilitating interactions between entities each belonging to a respective one of a plurality of different trust domains comprising the steps of:

creating a trust community which encompasses the trust domains;

allowing each trust domain to define its own security policy rules; and

providing a central body to enforce the security policy rules of each trust domain within the community. A trust broker entity may be provided for creating the community and to act as said central body.

According to another aspect of the invention there is provided a method of trust management and security policy enforcement wherein a central body cross certifies with each of a plurality of trust domains to form a trust community and that central body or a different central body enforces security policy rules defined by the trust domains. Preferably there is a common central body, which may be termed a trust broker and which performs the certifying and enforcing functions.

According to another aspect of this invention there is provided a method for trust management and security enforcement wherein a central body acts as trust anchor or central hub of trust relationships in order to establish a trust community in which boundaries can be defined and over which control can be exercised.

According to another aspect of this invention there is provided a system comprising a trust broker which operates as a trust anchor or acts as a central hub of a plurality of trust domains and as a security policy enforcement entity for enforcing the security rules of each trust domain.

According to another aspect of the invention there is provided a trust and security management system comprising a trust broker which is arranged to act both as a bridge certification authority between a plurality of trust domains and as a security policy enforcement entity for enforcing the security policy rules of each trust domain.

According to another aspect of the invention there is provided a method for facilitating interactions via communications networks between computer systems of entities, wherein each entity belongs to a respective one of a plurality of different trust domains, the method comprising the steps of:

creating a trust community which encompasses the trust domains;

allowing each trust domain to define its own security policy rules; and

providing a central body to enforce the security policy rules of each trust domain within the community.

According to another aspect of the invention there is provided a method for facilitating interactions between entities which belong to respective, different trust domains by virtue of having a digital certificate anchored within the respective domain, comprising the steps of:

creating a trust community which encompasses the trust domains;

allowing each trust domain to define its own security policy rules; and

providing a central body to enforce the security policy rules of each trust domain within the community.

According to another aspect of the invention there is provided apparatus for administering trust management and security policy enforcement comprising:

means for cross certifying with each of a plurality of trust domains to create a trust community encompassing said plurality of domains;

means for receiving information concerning the security policy within each trust domain;

means for receiving, from entities within the community, requests for a decision on the allowability of an activity;

means for making decisions on allowability based on received information concerning security policy; and

means for outputting decisions to requesting entities.

According to another aspect of the invention there is provided apparatus for administering trust management and security policy enforcement comprising:

a module for cross certifying with each of a plurality of trust domains to create a trust community encompassing said plurality of domains;

a module for receiving information concerning the security policy within each trust domain;

a module for receiving, from entities within the community, requests for a decision on the allowability of an activity;

a module for making decisions on allowability based on received information concerning security policy; and

a module for outputting decisions to requesting entities.

According to another aspect of the invention there is provided apparatus for administering trust management and security policy enforcement comprising:

a bridge certification authority module for cross certifying with each of a plurality of trust domains to create a trust community encompassing said plurality of domains; and

a trust engine and policy agent module for:

a) receiving information concerning the security policy within each trust domain;

b) receiving, from entities within the community, requests for a decision on the allowability of an activity;

c) making decisions on allowability based on received information concerning security policy; and

d) outputting decisions to requesting entities.

The information concerning security policy may be delivered to the appropriate means/module and/or may be actively sought. The information may include security policy rules. The information may include data needed for use in conjunction with the rules.

The apparatus will typically be implemented on a plurality of computer systems. Typically, the computer systems will be interconnected via computer/communications networks. The modules will typically comprise hardware and software elements. There is essentially little or no limit on the geographical location of the various modules of the apparatus, further any module may in fact be distributed across a plurality of locations.

Typically any interactions between entities mentioned above will take place by making use of communications networks.

The apparatus may be termed as a trust broker apparatus.

According to another aspect of the invention there is provided a method of administering trust management and security policy enforcement comprising the step of providing a trust broker entity for:

cross certifying with each of a plurality of trust domains to create a trust community encompassing said plurality of the domains;

receiving information concerning the security policy within each trust domain;

receiving, from entities within the community, requests for a decision on the allowability of an activity;

making decisions on allowability based on received information concerning security policy; and

outputting decisions to requesting entities.

It will be noted that in the methods and apparatus defined above, the central body/trust broker/apparatus plays what might be considered a passive rather than an active role. In general terms the central body/trust broker/apparatus implements or enforces rules defined by individual domains and does not define, control or update those rules. This is not to say that a base level of rules (say for determining whether an entity or trust domain can enter the community) cannot be defined by the central body/trust broker/apparatus but rather that the central body/trust broker/apparatus need not define, control or update all of the rules which are applicable to the community. Only implementation/enforcement of those rules is required.

The principles of the invention may be implemented using one of a plurality of trust mechanisms as the method by which the trust domains' security and policy rules are enforced. Implementation of these methods may be enacted uniquely or collectively to form in combination a full implementation of trust broker enforcing systems.

The methods may be methods of public key infrastructure trust management and security policy enforcement and the apparatus may be public key infrastructure trust management and security policy enforcement apparatus.

According to another aspect of the invention there is provided a computer program, or set of computer programs, comprising code portions which when loaded and run on computer means cause the computer means to execute the steps defined in any one of the methods defined above.

According to another aspect of the invention there is provided a computer program, or set of computer programs, comprising code portions which when loaded and run on computer means cause the computer means to constitute any one of the apparatus defined above.

Clearly the computer means may comprise a plurality of individual computers which may be in different locations. The computer program or set of programs may be embodied on one or more data carriers. The or each data carrier might be a signal, or a record medium such as a disk.

Embodiments of the invention will now be described by way of example only with reference to the accompanying drawings in which:

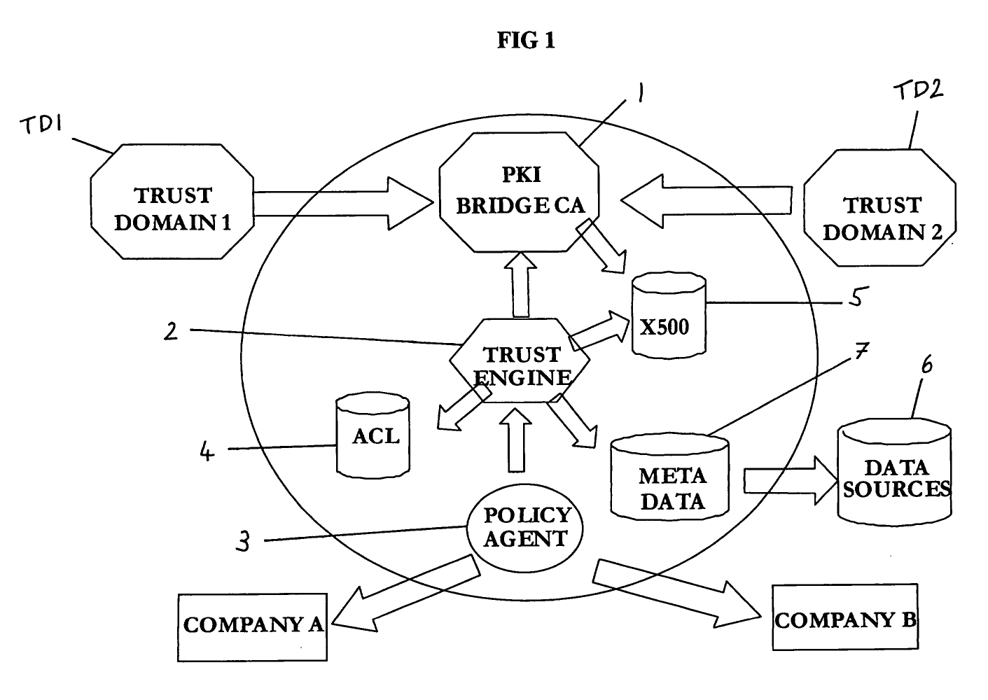

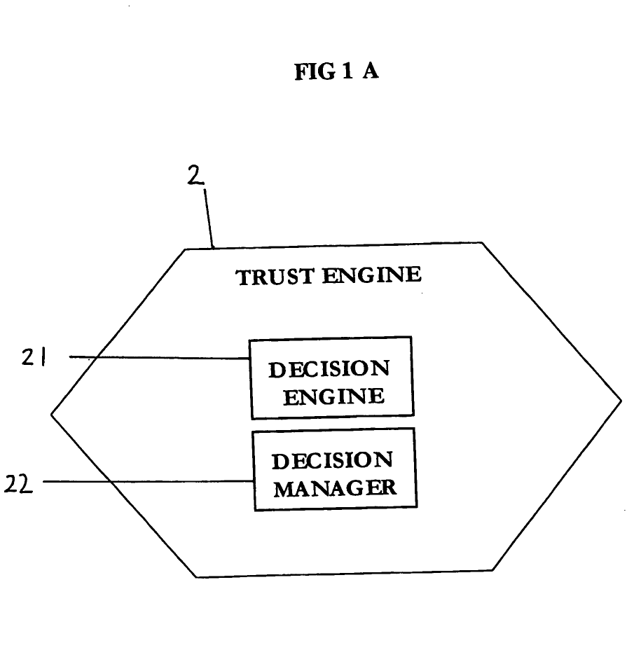

FIG. 1 shows a schematic architecture of a centralised trust broker system;

FIG. 1a shows more detail of a trust engine of the system shown in FIG. 1;

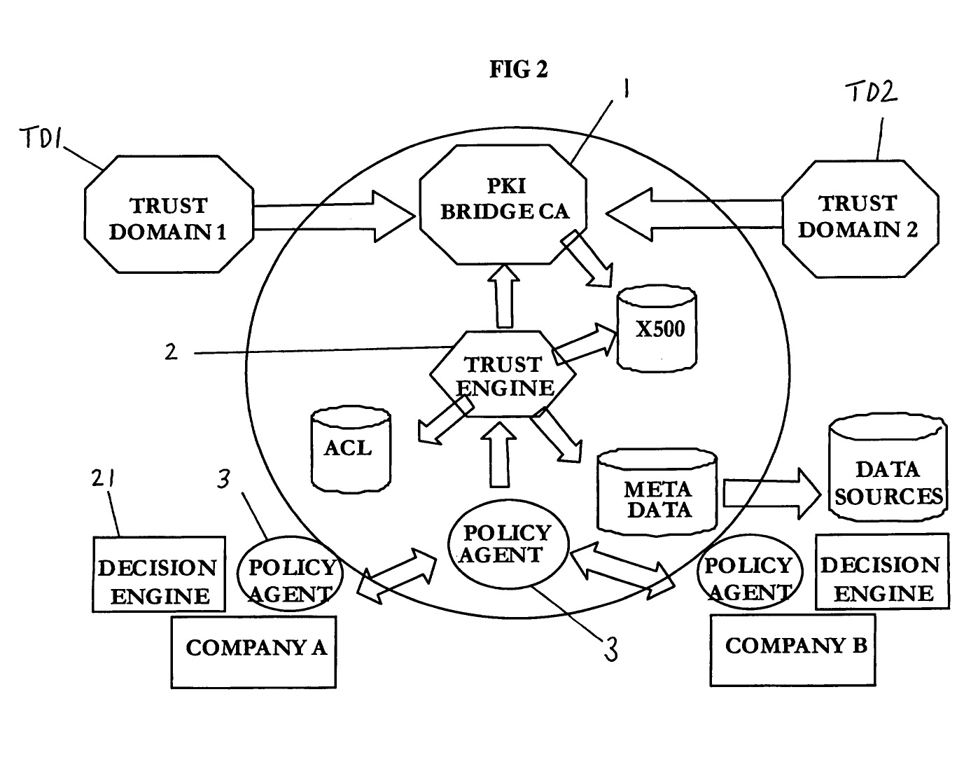

FIG. 2 shows a schematic architecture for a less centralised trust broker system;

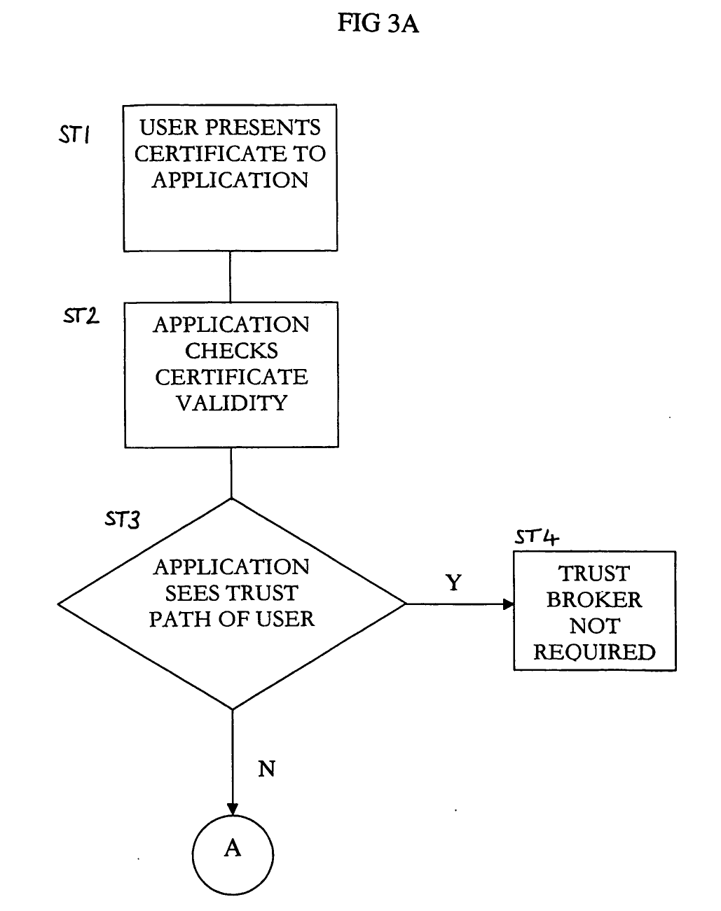

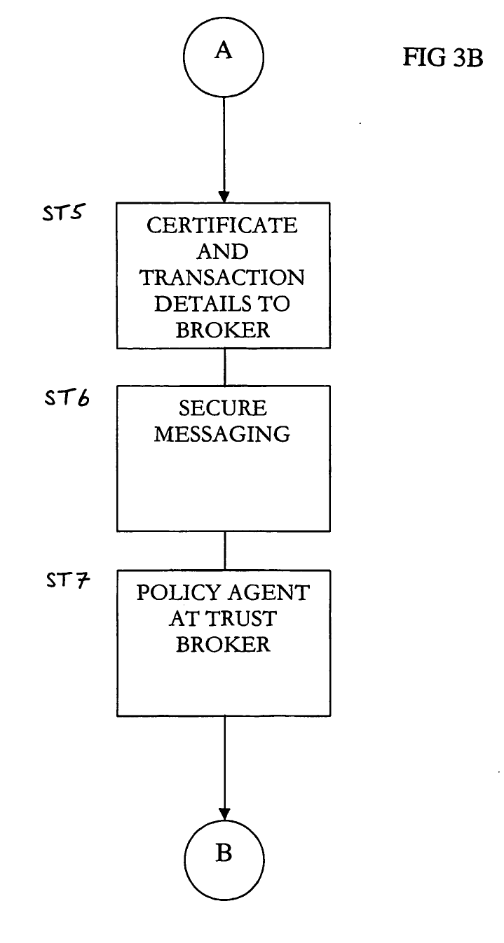

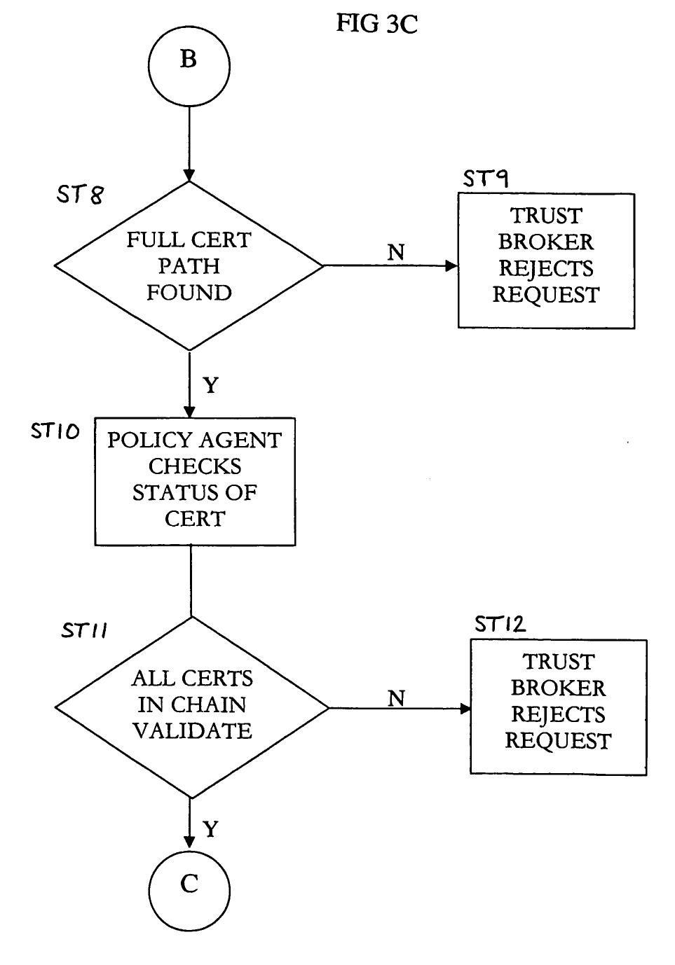

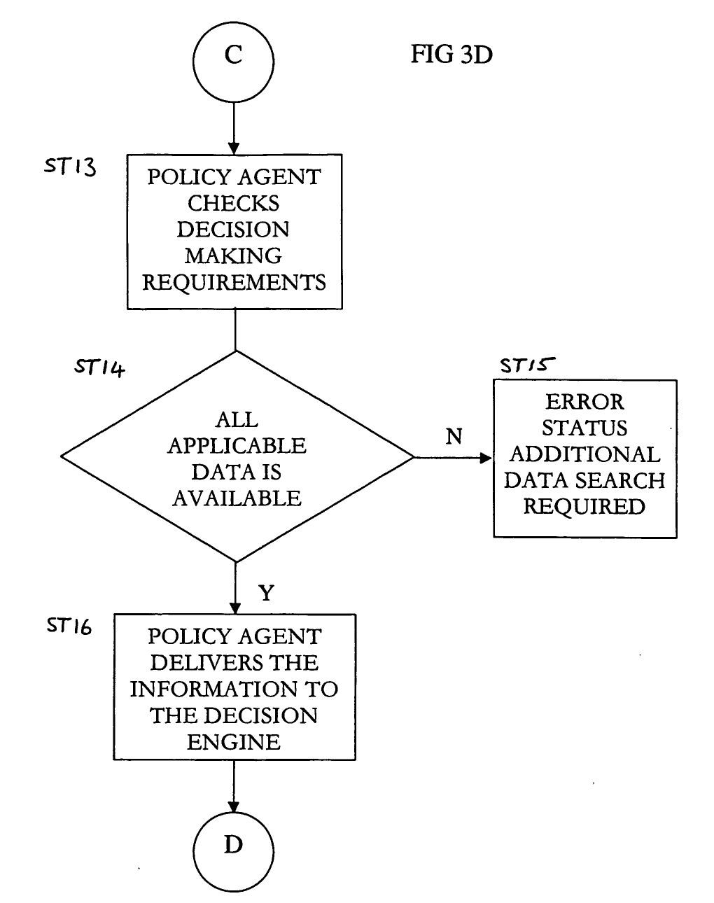

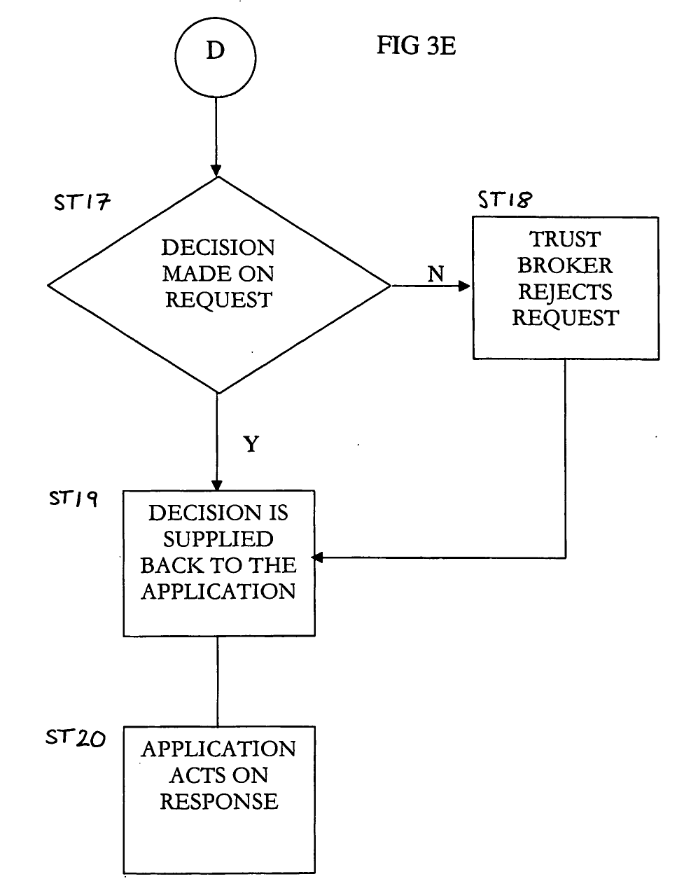

FIGS. 3A to 3E show a flow chart illustrating a typical trust broker process; and,

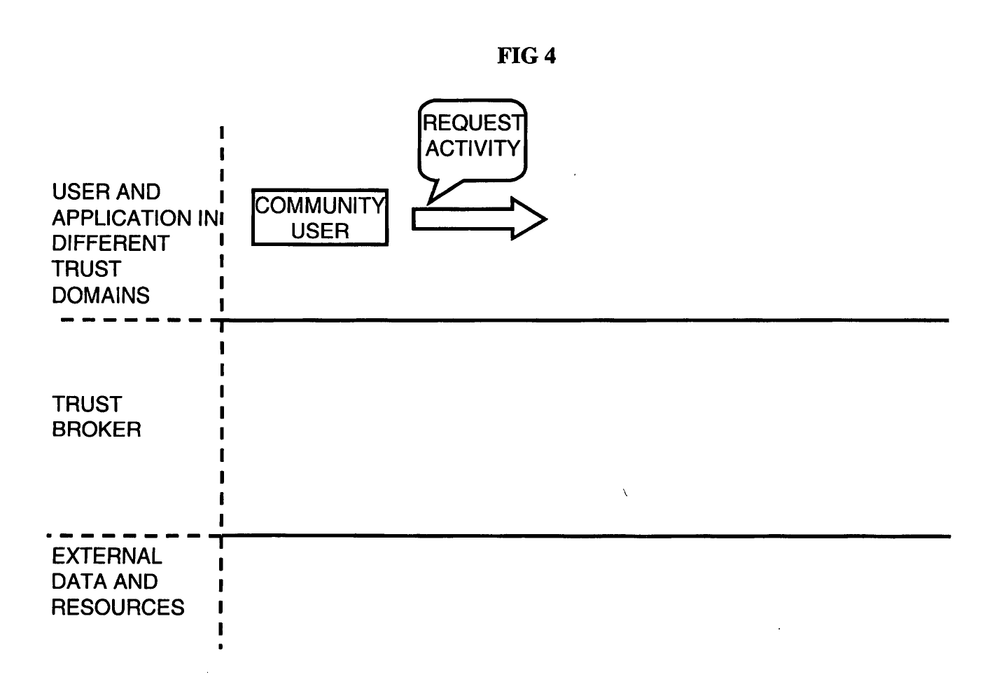

FIGS. 4 to 11 schematically illustrate another typical trust broker process in more detail.

This application generally relates to new concepts in the fields of electronic security trust etc., and to the implementation of the concepts. It is considered that once the concepts are explained, their detailed implementation is a straightforward matter for appropriately skilled people in these fields. Further, there are many possible ways in which the concepts may be implemented when looking at implementations at a detailed level and therefore description of detailed implementations are omitted.

It will be appreciated that in this specification the term “trust” is used to mean the well known concept within the field of secure interactions between computers (in their broadest sense; or the entities on behalf of which the computers are operating). To this extent trust is a technical manifestation of traditional trust relationships.

One of the most fundamental ideas in the present application is the concept of allowing entities which belong to different trust domains to interact with one another but in a controlled way. In the embodiments of the present invention described below this basic concept is implemented by use of an entity called a trust broker. The trust broker is used to link a plurality of otherwise distinct trust domains to form a trust community (an enlarged trust domain). This gives the possibility of interaction between entities in different trust domains. The trust broker also enforces/implements rules within the community on behalf of each and every trust domain.

In practice there will be a variety of different types of rules. A first set of rules are super rules or community rules which govern the behaviour of, and interactions within, the trust community as a whole. A second class of rules are entity rules which are specific to each entity which belongs to the trust community. Thus, there may be entity rules which apply to all members of a particular trust domain within the community but do not apply to entities which are not in that domain, and furthermore, there may be entity rules which apply only to a single entity or to a sub-set of entities within a particular domain. Beyond this it should also be noted that in the case of both entity rules and community rules there are different sub-sets of rules characterised by the aspects of e-security to which the rules relate. Therefore, there can be both entity rules and community rules which are security policy rules and trust rules, and moreover, the community security policy rules may include security policy management rules and the community trust rules may include trust management rules.

Trust management rules and security policy management rules are rules which control the types of or boundaries on rules that may be chosen and set up by entities in the community. Community trust and community security policy rules are normal types of rules which could be set by entities and are used in decision making but which apply to the whole community.

As examples a trust management rule might be “Members may not set Trust policies that do not accommodate reciprocal trust arrangements, i.e. you do not trust him but he has to trust you.”, a community trust rule might be “Members may trust each other only for transactions of value between £100 and £1000 and may not refuse to trust other members totally.”, and an entity trust rule may be “Member A sets a rule to indicate that entities in Member B's domain may execute trade up to a limit of £1000.”

Similarly a security policy management rule might be “Security policy rules for access to resources must ensure minimum authentication requirements are presented and enforced, i.e. Low Water Mark.”, a community security policy rule might be “A member must provide identifiable credential information for any entity requesting policy moderation by the Trust Broker even if the entity is in a trusted domain.”, and an entity security policy rule might be “Member A sets a rule that indicates that entities in Member B's domain may access data from its database for use in systems controlled by Member A.”

In many respects the distinction between these different types of rules is not that important, it is just important to note that the system is arranged to handle any type of rule relating to e-security which someone implementing the trust broker system may care to use. Further note that each entity which is going to be exposed to risk by virtue of a transaction and which is relying on security and trust to minimise that risk has the facility to use rules to set the security and trust levels that they require for different types of transaction.

It is also important to note that the trust broker (or entity which administers the trust broker) does not define the entity rules even though the trust broker does enforce the rules. The defining of entity rules is left within the control of each and every trust domain and in principle in the control of each and every entity. However, there may be various levels of control imposed upon the rules that can be defined by the entities. These controls in general will emanate from the trust broker but might also emanate from a particular domain in respect of entities which are members of that domain.

In general terms the trust broker stores or accesses the necessary rules and associated information and uses these to perform its enforcement function. This general idea allows each trust domain to have its own set of rules concerning what individual entities are permitted to do and indeed allows each entity to have its own rules without the associated problems encountered in existing systems. The following are true of the trust broker system:

1) It is possible for a trust domain to enter the community without having to trust every entity for all purposes as would be the case in the simplest systems. Furthermore, the interaction between each user and each other user within the community can be individually moderated and controlled. There is no need to build up or suffer from a web of trust. For example, the fact that A trusts B and B trusts C in respect of a certain action need have no influence on A and C's trust relationship.

2) The use of attribute digital certificates, which can become cumbersome in practical implementations is avoided.

3) There is no need for the trust broker to define and maintain policy rules or create and assign differing levels of trust for different entities or domains.

4) Individual domains do not need to keep databases of rules in respect of other domains which would need continual updating.

5) A relying party in the community is able to prescribe the trust rules it requires to be enforced on its behalf by the trust broker. For the avoidance of doubt, it is mentioned that a relying party is an entity within the trust community which makes use of and relies on the trust relevant information and trust status of another entity in the community.

Put another way the trust broker system allows great flexibility and control for trust domains and individual entities within trust domains without imposing a huge administrative burden on any single entity, domain etc.

Thus the systems of the present application:

can be thought of as a model to allow flexible, pragmatic implementation of business relationships in electronic transactions;

provide a mechanism to allow working across multiple trust domains using a structure that allows rigour in implementation of trust policy; and

form a framework onto which specific solutions can be built.

The trust broker can be thought of as being an entity that enables and administers a trust broker implementation for a trust community. Moreover, the trust broker manages and controls the policy for broker operations, is trusted in implementing the policy, business and technical components to support trust brokering but is not a trusted third party and does not prescribe trust relationships.

These concepts and ideas will be made clearer by consideration of and description of the accompanying drawings which show schematic architectures for implementing a trust broker system and illustrate trust broker processes.

FIG. 1 schematically shows a centralised trust broker system. In this case those components which make up the trust broker can be considered to be those which sit within the circle shown in FIG. 1. However, it should be borne in mind that there is a certain degree of flexibility in which components actually form part of the trust broker and even more flexibility in the physical location of the necessary hardware to implement the system. Thus, throughout this description where elements are described as being part of the trust broker, this does not necessarily mean that they are all situated in one central location but rather suggests that the elements are all under the control of the trust broker and are performing tasks associated with the trust broker process.

The trust broker system will typically be implemented on a number of computer systems running appropriate software and these computer systems, as alluded to above, may be located in one central location or may be dispersed across different locations as is most convenient. In some instances a single functional module or part of the trust broker implementation may be distributed across several different computer systems.

In this example there are two trust domains TD1 and TD2 each of which have a plurality of members. In FIG. 1, only two members are shown; company A which belongs to the first trust domain TD1 and company B which belongs to the second trust domain TD2.

The trust broker comprises a bridge (or hub) certification authority (bridge CA) module 1. The function of this module 1 is to unify the two trust domains TD1, TD2 so as to form a trust community within which transactions may take place. It will be understood that this unifying process does not merge the domains indistinguishably into one another but gives a trust path to allow the remainder of the trust broker process to take place. At the heart of the trust broker is the trust engine 2 which as a whole is responsible for the control of electronic transactions within the trust community formed by the bridge CA 1. A policy agent module 3 is provided and acts in general terms as an interface between the trust engine 2 and the computer systems of entities within the trust community, i.e. in this case, the computer systems of company A and company B.

The trust engine 2 has access to various sources of information for use in performing its role. These data sources include an access control list 4, an X500 database 5 (X500 being a directory standard which is used in the e-security industry) and external data sources 6 which are accessible via a meta data module 7. These data sources will include information which is needed when making decisions as to whether a particular transaction will proceed. The precise nature of the data which is required will depend on the type of transactions which are taking place. However, in this particular embodiment these pieces of data will not include the rules themselves which will be used for making decisions as these are stored elsewhere.

As shown in FIG. 1A the trust engine 2 comprises a decision engine 21 and decision manager 22 as sub-components. It is the decision engine 21 which stores the rules mentioned above.

The function and interaction of the components introduced above will now be described in more detail.

As mentioned above the bridge certification module 1 has a function of acting as a trust bridge between the different trust domains. It should be noted that the use of a bridge certification authority is only one possible form of trust bridge that might be used. This is an appropriate form of trust bridge where the trust community operates using digital certificates. However, in implementations where digital certificates are not used, and other credentials (eg user name/password) are used in their place, the trust bridge will take another form but will carry out a similar role in ensuring that there is a trust path between the domains unified by the trust broker. As part of its role, the bridge CA module 1 performs a certificate discovery operation which includes checking that certificates are valid and meet the requirements for use within the trust community.

The rules stored in the decision engine 21 will include both community rules and entity rules.

The decision manager 22 is provided to collect up-to-date information in relation to entity rules and forward these to the decision engine 21 so that the database of rules is kept current. The decision manager 22 may function by actively seeking out new or amended entity rules at appropriate times. In other cases, the entity defining the rules will have direct access to the decision manager such that as an entity defines a new rule or amends an existing rule this is reflected in the decision manager 22 immediately.

In the present embodiment the decision manager 22 is located centrally on a trust broker computer but in some implementations the decision manager 22 may have a dispersed nature such that there is a part of the decision manager or a distinct decision manager located at computer systems of some or all of the entities which are members of the trust broker community.

The trust engine 2 itself has functions beyond those of the decision engine 21 and decision manager 22. In particular, the trust engine 2 receives requests for decisions concerning transactions from members of the trust community via the policy agent 3 and collects information concerning the context of these requests. The trust engine 2 then provides a contextualised request for decision to the decision engine 21 so that a decision can be made using the stored rules. The splitting of the decision making task into one where the trust engine 2 first builds a context for the request and then passes a contextualised request for a decision to the decision engine 21 is important because of the complex factors which need to be considered when making a decision. In this particular instance the role of the trust engine 2 can be thought of as finding the necessary facts to ask the right question and provide the raw materials for working out an answer. The decision engine 21 itself uses the rules and the raw material to answer the appropriate question or questions.

As mentioned above, the policy agent 3 acts as an interface between the trust engine 2 and the computer systems of company A and company B. Furthermore, in some instances policy agent modules may exist between the data sources 4, 5, 6 and 7 and the trust engine 2. In performing its interface role the policy agent 3 is important in not only allowing communication to take place but also providing a messaging system which is secure and robust. This is to ensure that there is no significant danger of the data which is being passed between the various entities being accessed, tampered with or corrupted without this at least being detected by the system.

Again, whilst in this particular embodiment, the policy agent 3 is shown to be located centrally, this is not necessary. Policy agent modules may be located wherever it is most appropriate or convenient, but wherever the policy agent 3 is located it must in general terms remain under the control of the trust broker.

FIG. 2 schematically shows a different possible implementation of a trust broker system. In this case the system is rather less centralised in that policy agent modules 3 are provided at the sites of company A and company B as are parts of the trust engine 2 in the form of parts of the decision engine 21. However, these different physical locations of the policy agents 3 and parts of the decision engine 21 have no real effect, at a conceptual level, on the operation of the system as a whole since the central trust engine 2 is in communication with the local parts of the decision engine 21 located at companies A and B.

Of course, however, the distributed nature of the system shown in FIG. 2 can help to make use of computing power located at company A and B rather than simply using computed power located at a site under the control of the organisation administering the trust broker system.

The local parts of the decision engine 21 provided at the sites of company A and B may contain a sub-set of rules which are particularly appropriate for use in transactions by the respective company and in some instances this may lead to faster processing of requests relating to the allowability of transactions.

FIGS. 3A to 3E show a flow chart for a typical trust broker process which may be carried out using a trust broker system of a type similar to that described above. The general context for this process is that a user who has a digital certificate issued by a member of a trust domain which itself is part of a trust community wishes to perform a particular transaction which is managed by an application program with which the user can interact.

In step ST1 the user presents a digital certificate to the application by virtue of attempting to initiate the transaction which he wishes to carry out. At step ST2 the application checks the validity of the certificate.

In step ST3 one of two things can happen as the result of this check. Either the application sees a trust path for the user which is sufficient for the transaction to be carried out, in which case the process is at an end (step ST4) and the trust broker is not required, or no trust path can be seen.

In this second case we move onto step ST5 where the certificate and transaction details are sent to the trust broker by the application. As part of this process, at step ST6, necessary information is coded into a secure messaging transport system and forwarded on to the policy agent located at the trust broker, step ST7.

In step ST8 the policy agent at the trust broker uses the trust engine to start a certificate checking process typically known as certificate discovery. As a first part of this process a check is made that there is a full certificate path. If a full certificate path is not found the trust broker rejects the request at step ST9. If, on the other hand, a full certificate path is found we move to step ST10 where the policy agent uses the trust engine to check the status of the certificates.

This results in the trust engine checking whether all of the certificates in the chain are valid at step ST11. If this is not the case the trust broker rejects the request at step ST12. On the other hand, if all the certificates in the chain do validate, the process moves on to step ST13 where the policy agent, again making use of the trust engine, checks whether the decision making requirements have been met in the message. This results in a check being made that all the applicable data is available at step ST14. If some data is missing then at step ST15 an error status is entered and a search for additional data is commenced.

If, however, all the data is present (which might be, for example, after the additional data has been requested and received) the policy agent and trust engine deliver the information including the appropriate request for a decision to the decision engine at step ST16.

In step ST17, the decision engine makes the appropriate decision on the request being made making use of the information provided by the policy agent, the rules stored in the decision engine and contextual information gathered and processed by the trust engine. At this stage a yes or no decision on the transaction is made. If the decision is no then at step ST18 the trust broker rejects the request. It will be appreciated that the rules used in the decision making process will include any pertinent community trust and community security policy rules as well as pertinent entity rules associated with both parties involved. Thus the transaction will be stopped if it would breach any rule in this set of rules.

At step ST19 the result of the trust brokering process is supplied back to the application. The decision returned, in essence will either be a yes decision (meaning that everything is in order and the transaction can proceed) or a no decision if the trust broker has rejected the request at any of steps ST9, ST12 or ST18.

Once the decision is supplied back to the application, the application may act on the response as appropriate, carrying on and completing the transaction where there has been a yes decision.

FIGS. 4 to 11 schematically show a similar process to that described in relation to FIGS. 3A to 3E. However, this relates to a different scenario and more detail is shown concerning the roles which the different elements or modules of the trust broker system take.

In the trust broker process illustrated in FIGS. 4 to 11 the particular transaction which is being considered is an attempt by a user, who is a member of one trust domain within the trust community, to make use of an application which is located in a different trust domain within the trust community. Thus there is a question as to whether the user is entitled to use this application and the trust brokering process as described below is used to determine whether the use of the application is allowed in the particular set of circumstances which relate to the particular request being made. These circumstances need not be limited to just the identity of the user and the application but may be influenced by a vast number of other factors such as the time of day, whether the application has sufficient resources to accommodate the user at present, whether the task which the user wishes to perform is an accepted task, etc. This process, however, is transparent to the user.

Initially, as shown in FIG. 4, the user tries to access the desired application. As the user attempts to access the application, his computer system presents his credential, for example a digital certificate. This results in the user's computer system initiating a request for a decision as to whether access is allowed. The request is accepted and received by a policy agent which gathers relevant data, formats the request, establishes its context and delivers this information via a secure messaging system to the trust broker as illustrated in FIG. 5.

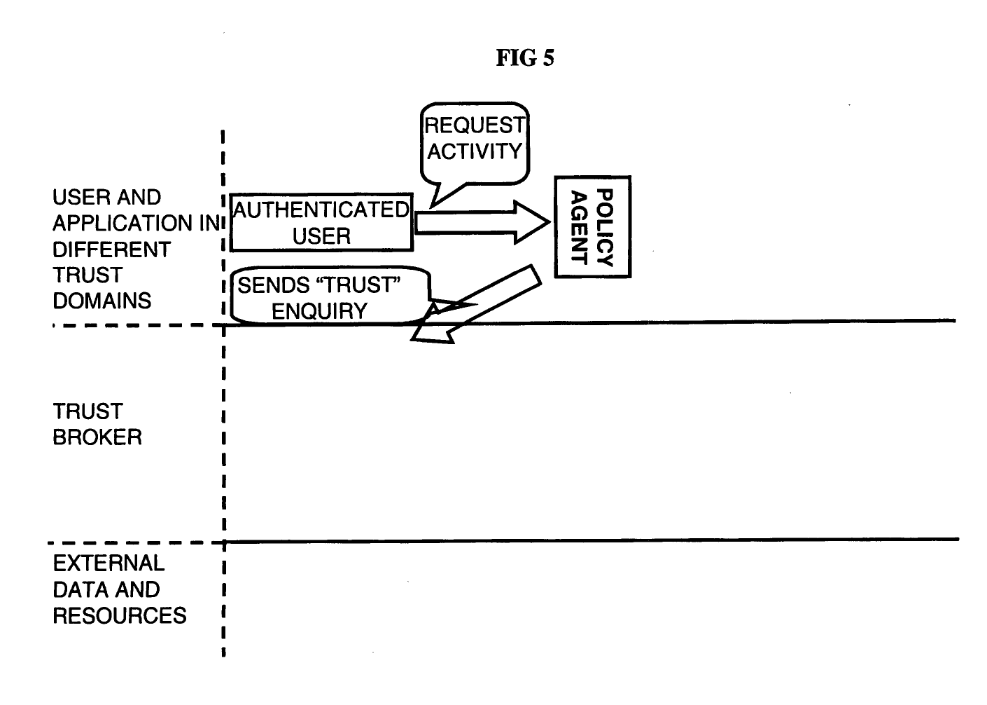

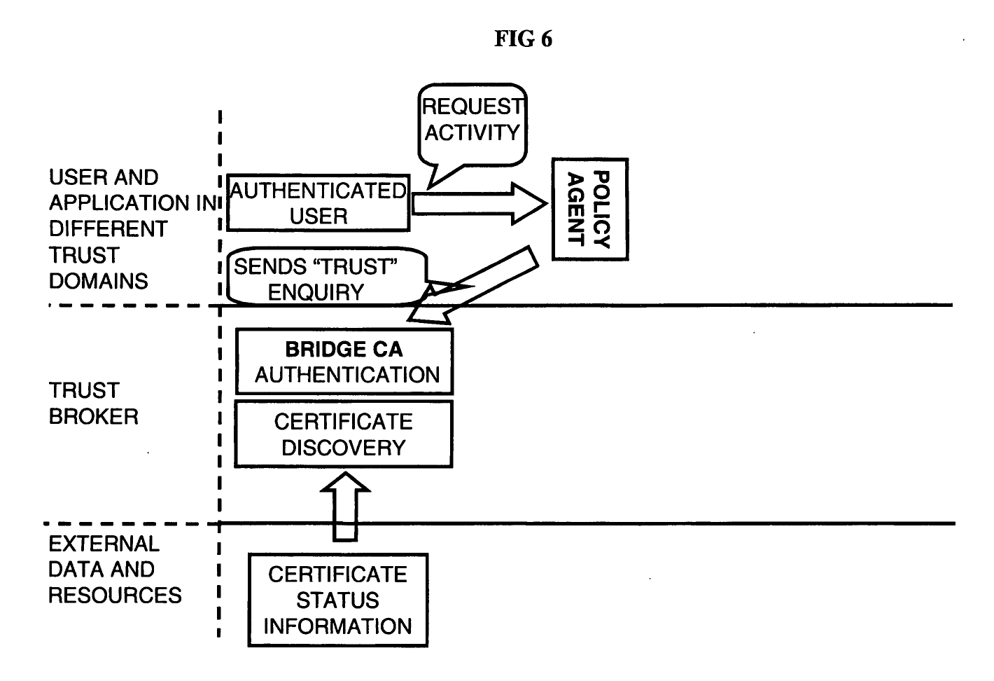

The trust broker receives this request and carries out validation status and authentication tasks, in this instance acting as a bridge certification authority and using a certificate discovery process. Here, as shown in FIG. 6, the certificate status information is gained from an external data source and used by the bridge certification authority of the trust broker.

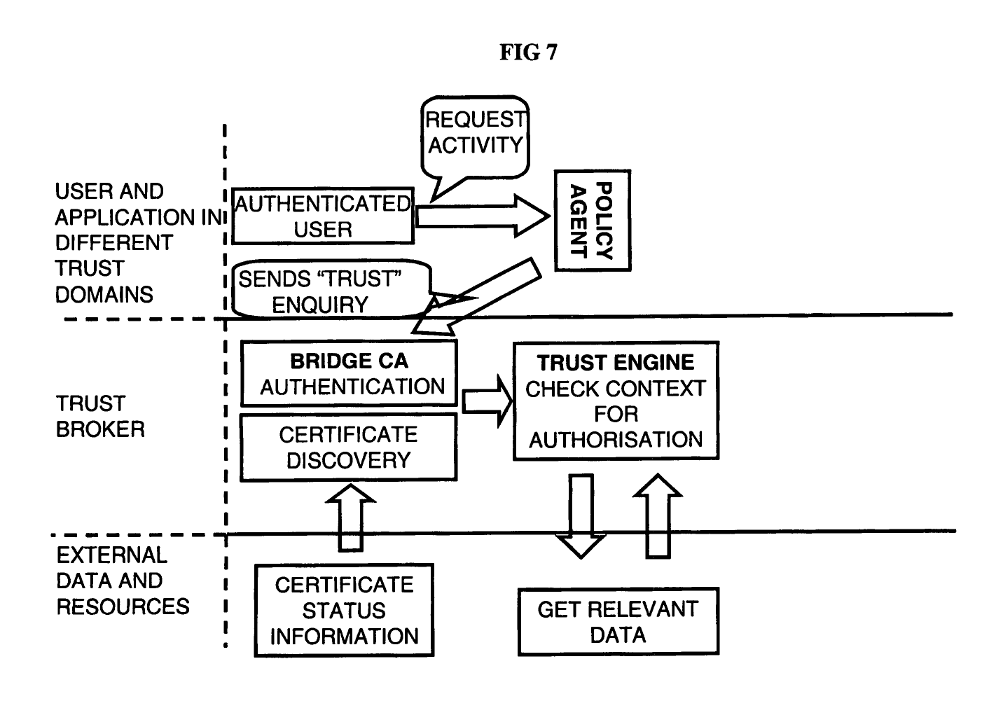

Once the authenticated user is validated through the certificate discovery process, a request for a decision is passed to the trust engine. The trust engine establishes the context of the request and collects relevant information as illustrated in FIG. 7. At least some of the data which is required in this case is again from an external resource.

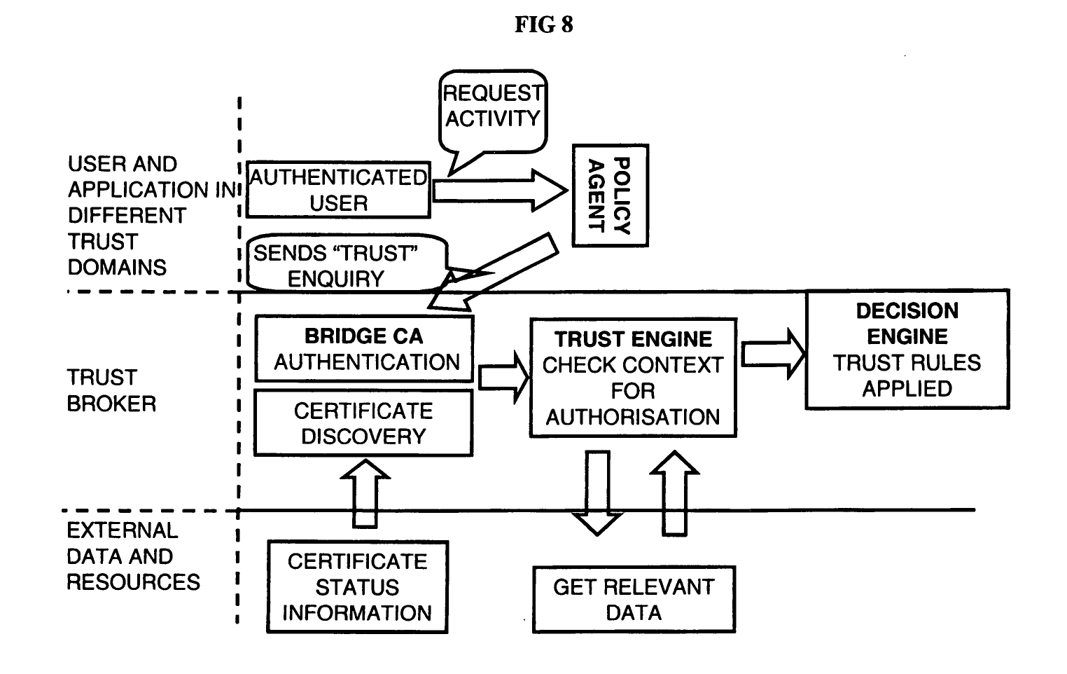

After the data gathering and contextualisation is complete the trust engine passes a contextualised request to the decision engine as illustrated in FIG. 8. The decision engine applies the rules of the trust community as a whole and the rules of the entities involved to determine whether the transaction can proceed.

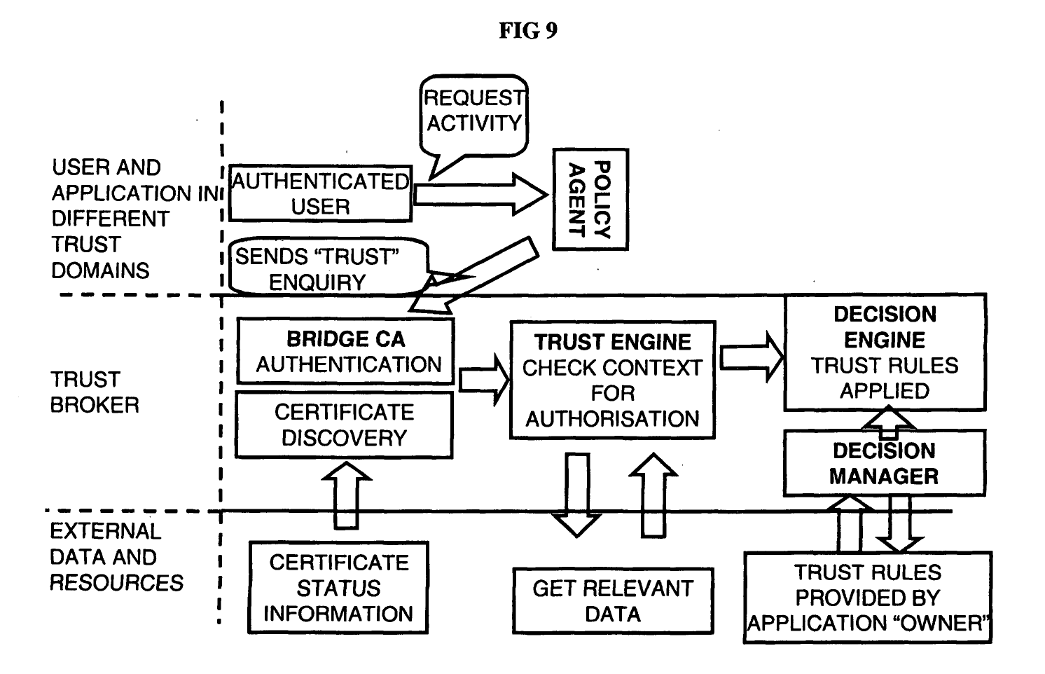

As illustrated in FIG. 9 the entity rules stored at the decision engine are supplied via the decision manager which either collects or receives these rules from the relevant entities.

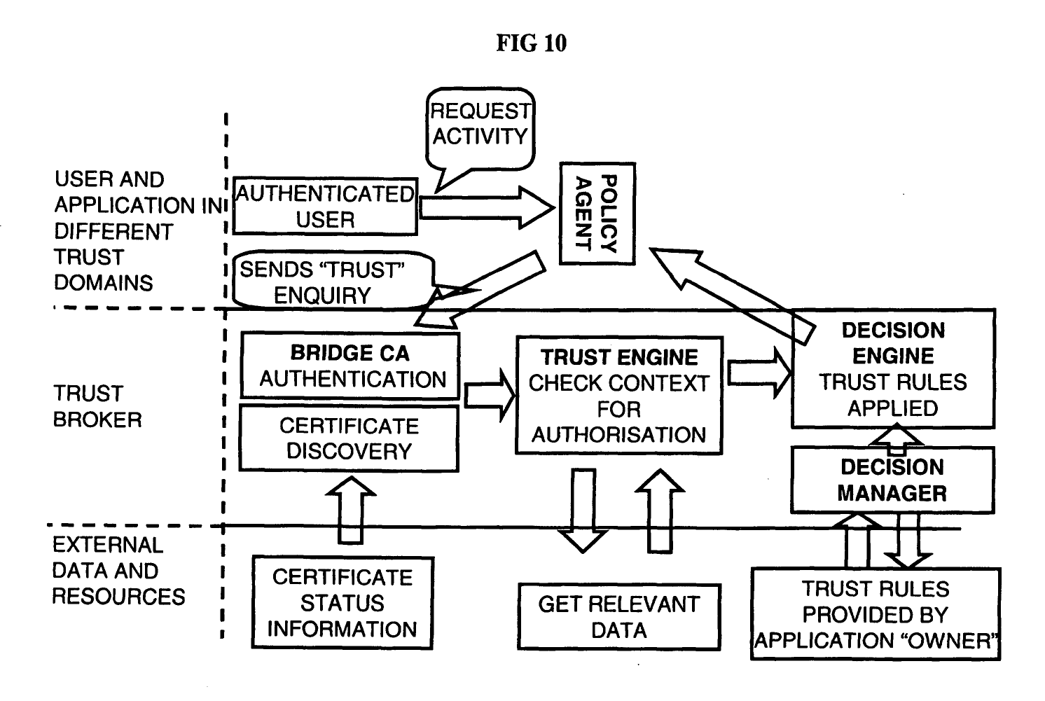

As illustrated in FIG. 10, the decision engine outputs a decision to the policy agent having applied the appropriate rules. Assuming that the decision is positive the requested access can proceed.

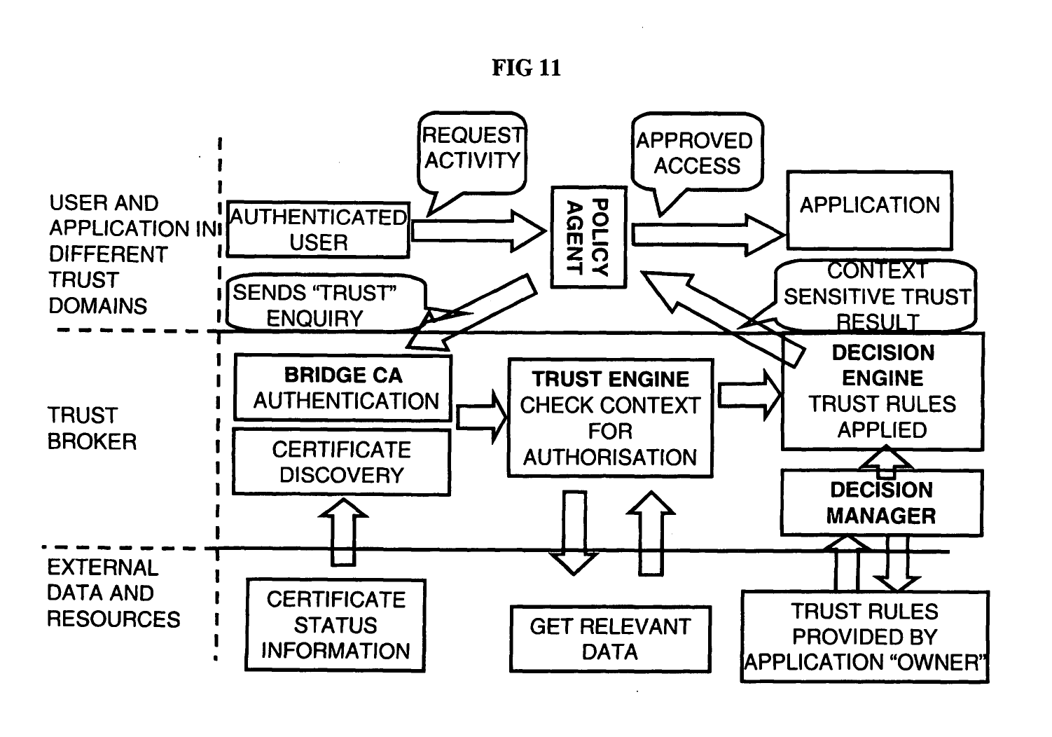

The decision which has been made is a context sensitive trust result such that the approval given is based on the entire context. It should be noted that a very similar request made by the same user might be refused in future if some aspect of the context means that a different decision has to be made. For example, the user might be allowed access to the application concerned only at certain times during the day or week. In the case shown in FIG. 11 it is assumed that the decision is positive and therefore access to the application is approved.

Whilst the majority of the above description has been given in conceptual terms it will be appreciated that apparatus may be provided for carrying out the functions and processes described and more particularly in many implementations the apparatus will take the form of one or more computer systems operating under the control of appropriate software. Moreover, this software may exist on appropriate computer readable data carriers such as electronic signals or data storage means such as floppy disks, hard disks or CD roms. Moreover, in some instances there may be a plurality of different computer systems which may or may not be located in different locations and each of these may run a respective part of the software used to implement the system as a whole. There may also be computer program products such as CD roms carrying the necessary software for loading into such a plurality of different computer systems.

In summary it can be noted that the trust broker system tackles the problem of interoperability and interaction between organisations that wish to enable trust relationships electronically, typically as part of normal business operations. It comprises a model which combines PKI trust management (or other types of trust domain management) via a trust bridge and security policy enforcement (access, authorisation and privilege) to give a mechanism which fully defines the trust and privileges for a given activity.

As the trust broker is not attempting to control or take responsibility for each particular trust relationship between community members it does not have to prescribe or legislate for every aspect of interaction or relationship. Because of this, the definition of the boundaries of the trust environment policies can be much less complex than those generally encountered in trust interoperability projects.

The trust broker on behalf of the community uses procedural and technical means to manage and enforce the policies that define the boundaries of operation within the community.

As a tool kit for building communities of trust, the trust broker builds on accepted models and standard mechanisms for defining and publishing policy. The trust broker provides, via the rule bases that comprise the decision manager, the framework and tools to establish relationships with other community members as it sees fit.

Community members establish their relationships with other parties in the community context at the level they consider appropriate, enacting such business documentation as they see fit to support the relationship.

It will be appreciated that there are a wide range of activities and transactions which may benefit from the trust broker process. One area of particular interest however, is financial transactions, for example, between banks where there may be monetary limits associated with different levels of trust.

1. A method for facilitating interactions via communications networks between computer systems of entities, wherein each entity belongs to a respective one of a plurality of different trust domains, the method comprising the steps of:
creating a trust community which encompasses the trust domains;
allowing each entity in the community to define its own entity rules; and
using a central body to enforce the entity rules of each entity within the community.

2. A method according to claim 1 wherein the entity rules comprise security policy rules and/or trust rules.

3. A method according to claim 1 or claim 2 wherein a trust broker creates the trust community and acts as the central body to enforce the entity rules.

4. A method according to any one of claims 1 to 3 comprising the step of using at least one computer system for:
receiving information concerning trust and/or security policy within each trust domain;
receiving, from entities within the community, requests for a decision on the allowability of an activity;
making decisions on allowability based on received information concerning trust and/or security policy; and
outputting decisions to requesting entities.

5. A method according to claim 4 comprising the step of receiving and/or collecting and subsequently processing information concerning the context of requests for decisions from entities.

6. A method according to claim 4 or claim 5 comprising the step of storing entity rules at a computer system of the central body and/or at a location accessible to a computer system of the central body and making decisions at the central body using the stored rules in response to requests for decisions from entities.

7. A method according to claim 5 comprising the step of storing entity rules at a computer system of the central body and/or at a location accessible to a computer system of the central body;
deriving contextualised requests for decisions based on a respective decision request received from an entity and information concerning the context of that request; and
making a decision at the central body on the basis of the contextualised request and the stored rules.

8. A method according to any preceding claim in which the trust community has a set of community rules and the method includes the step of using the central body to enforce the community rules in addition to the entity rules of each entity in the community.

9. A method according to claim 6 or 7 comprising the steps of storing community rules in addition to the entity rules and using the community rules in the decision making step.

10. A method according to claim 8 or claim 9 wherein the community rules comprise community security policy rules and community trust rules, the security policy rules may include security management rules and the trust rules may include trust management rules.

11. A method according to any preceding claim wherein each entity belongs to its respective trust domain by virtue of having a digital certificate anchored within the respective domain.

12. A method according to any preceding claim wherein the step of creating a trust community comprises the step cross certifying between the plurality of trust domains.

13. A method according to any preceding claim which is a method of public key infrastructure trust management and security policy enforcement.

14. A method according to any one of claims 1 to 10 wherein each entity belongs to its respective trust domain by virtue of having a security token which is managed and controlled under the policies of the respective trust domain.

15. A method according to claim 14 wherein the step of creating a trust community comprises linking by use of security tokens.

16. A method according to any preceding claim wherein the step of creating a trust community comprises linking by use of security assertions.

17. Apparatus for administering trust management and security policy enforcement comprising:
means for creating a trust community encompassing a plurality of trust domains;
means for receiving information concerning trust and/or security policy within each trust domain;
means for receiving, from entities within the community, requests for a decision on the allowability of an activity;
means for making decisions on allowability based on received information concerning trust and/or security policy; and
means for outputting decisions to requesting entities.

18. Apparatus according to claim 16 comprising:
a trust community creation module for creating the trust community encompassing said plurality of domains; and
a trust control system for:
a) receiving information concerning trust and/or security policy within each trust domain;
b) receiving, from entities within the community, requests for a decision on the allowability of an activity;
c) making decisions on allowability based on received information concerning trust and/or security policy; and
d) outputting decisions to requesting entities.

19. Apparatus according to claim 17 or claim 18 wherein the trust community creation module is a bridge certification authority module for cross certifying with each of the plurality of trust domains.

20. Apparatus according to any one of claims 17 to 19 wherein the trust control system comprises at least one policy agent module acting as an interface between computer systems of the central body and computer systems of entities within the community.

21. Apparatus according to claim 20 wherein a policy agent module is disposed at at least one of the following locations: the central body, a server, a gateway of a computer infrastructure, a component of a computer infrastructure, and an entity computer system, in any case the policy agent module being arranged to operate under the control of the central body.

22. Apparatus according to any one of claims 17 to 21 wherein the trust control system comprises a trust engine module for receiving and/or collecting and subsequently processing information concerning the context of requests for decisions from entities.

23. Apparatus according to any one of claims 17 to 22 wherein the trust control system comprises at least one decision engine module for storing security policy rules and/or trust rules and making decisions in response to requests for decisions.

24. Apparatus according to claim 22 wherein the trust control system comprises at least one decision engine module for storing security policy rules and/or trust rules and making decisions and the trust engine is arranged to output, to the decision engine, contextualised requests for decisions, based on a respective decision request received from an entity and information concerning the context of that request.

25. Apparatus according to claim 23 or claim 24 wherein the security policy rules and/or the trust rules which the decision engine is arranged to store comprise community rules applicable to the community and entity rules chosen by and applicable to respective entities within the community.

26. Apparatus according to any one of claims 23 to 25 wherein the decision engine is arranged to output decisions to entities via a policy agent module.

27. Apparatus according to any one of claims 23 to 26 in which the trust control system comprises at least one decision manager module for collecting and/or receiving rules from entities and for providing the decision engine access to any collected or received rules.

28. Apparatus according to any one of claims 17 to 27 which is public key infrastructure trust management and security policy enforcement apparatus.

29. A computer program, or set of computer programs, comprising code portions which when loaded and run on computer means cause the computer means to execute a method according to any one of claims 1 to 16.

30. A computer program, or set of computer programs, comprising code portions which when loaded and run on computer means cause the computer means to constitute apparatus according to any one of claims 17 to 28.

31. A computer program according to claim 29 or 30 in which the computer means comprises a plurality of individual computers which may be in different locations.

32. A computer readable data carrier carrying thereon a computer program according to any one of claims 29 to 31.

33. A set of computer readable data carriers carrying thereon a set of computer programs according to any one of claims 29 to 31.

34. A method of facilitating interactions between entities wherein each entity belongs to a respective one of a plurality of trust domains the method comprising the steps of:
creating a trust community which encompasses the trust domains;
allowing each entity which is member of the trust community to define its own rules, the rules comprising at least one of trust rules and security policy rules; and
using a computer system of a central body to make decisions based on the rules, which decisions are usable in controlling interactions between the entities.

35. A method for managing interactions between entities each belonging to a respective one of a plurality of different trust domains comprising the steps of:
creating a trust community which encompasses the trust domains; and
controlling the activities of entities within the community.

36. A method for managing interactions between entities each belonging to a respective one of a plurality of different trust domains comprising the steps of:
creating a trust community which encompasses the trust domains;
allowing each trust entity to define its own trust and/or security policy rules; and
providing a central body to enforce the trust and/or security policy rules of each entity within the community.

37. A method for facilitating interactions between entities each belonging to a respective one of a plurality of different trust domains comprising the steps of:
creating a trust community which encompasses the trust domains;
allowing each entity to define its own trust and/or security policy rules; and
providing a central body to enforce the trust and/or security policy rules of each entity within the community.

38. A method of trust management and security policy enforcement wherein a central body cross certifies with each of a plurality of trust domains to form a trust community and that central body or a different central body enforces trust and/or security policy rules defined by the entities.

39. A trust and security management system comprising a trust broker which is arranged to act both as a bridge certification authority between a plurality of trust domains and as a trust and/or security policy enforcement entity for enforcing trust and/or security policy rules of the entities.

40. Apparatus for administering trust management and security policy enforcement comprising:
a module for creating a trust community encompassing a plurality of trust domains;
a module for receiving information concerning security policy and/or trust within each trust domain;
a module for receiving, from entities within the community, requests for a decision on the allowability of an activity;
a module for making decisions on allowability based on received information concerning trust and/or security policy; and
a module for outputting decisions to requesting entities.
